(19) United States
(12) Patent Application Publication
(10) Pub. No.: US 2023/0145582 A1
(43) Pub. Date: May 11, 2023

(54) PRIMARY CARRIER AND SECONDARY CARRIER NEGOTIATION IN SIDELINK

(71) Applicant: QUALCOMM Incorporated, San Diego, CA (US)

(72) Inventors: Anantharaman Balasubramanian, San Diego, CA (US); Shuanshuan Wu, San Diego, CA (US); Kapil Gulati, Belle Mead, NJ (US)

(21) Appl. No.: 17/454,161

(22) Filed: Nov. 9, 2021

(51) Int. Cl. H04W 28/18; H04W 72/04; H04W 64/00

(52) U.S. Cl. CPC H04W 28/18; H04W 72/048; H04W 64/00; H04W 72/0406; H04W 72/0453

(57) ABSTRACT

Various aspects of the present disclosure generally relate to wireless communication. In some aspects, a first mobile station may transmit a signal on each of multiple sidelink carriers. The first mobile station may receive one or more signals on one or more of the multiple sidelink carriers. The first mobile station may select a primary carrier among the multiple sidelink carriers and a secondary carrier among the multiple sidelink carriers based at least in part on the signals received on multiple sidelink carriers. The first mobile station may negotiate which of the multiple sidelink carriers are to be an agreed primary carrier and an agreed secondary carrier. Numerous other aspects are described.

### FIELD OF THE DISCLOSURE

Aspects of the present disclosure generally relate to wireless communication and to techniques and apparatuses for primary carrier and secondary carrier negotiation in sidelink.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a first mobile station. The method may include transmitting, by the first mobile station to a second mobile station, a signal on each of multiple sidelink carriers. The method may include receiving, by the first mobile station from the second mobile station, one or more signals on one or more of the multiple sidelink carriers. The method may include selecting, by the first mobile station, a primary carrier among the multiple sidelink carriers and a secondary carrier among the multiple sidelink carriers based at least in part on the one or more signals received on the one or more of the multiple sidelink carriers. The method may include negotiating, by the first mobile station with the second mobile station, which of the multiple sidelink carriers are to be an agreed primary carrier and an agreed secondary carrier.

Some aspects described herein relate to a method of wireless communication performed by a network entity. The method may include receiving, by the network entity from a mobile station, one or more of a capability of the mobile station or a location of the mobile station. The method may include transmitting, by the network entity to the mobile station, an indication of one or more of a primary carrier or a secondary carrier selected by the network entity based at least in part on the capability of the mobile station and the location of the mobile station.

Some aspects described herein relate to a first mobile station for wireless communication. The first mobile station may include a memory and one or more processors. The one or more processors may be configured to, based at least in part on information stored in the memory, transmit a signal on each of multiple sidelink carriers. The one or more processors may be configured to receive one or more signals on one or more of the multiple sidelink carriers. The one or more processors may be configured to select a primary carrier among the multiple sidelink carriers and a secondary carrier among the multiple sidelink carriers based at least in part on the one or more signals received on the one or more of the multiple sidelink carriers. The one or more processors may be configured to negotiate which of the multiple sidelink carriers are to be an agreed primary carrier and an agreed secondary carrier.

Some aspects described herein relate to a network entity for wireless communication. The network entity may include a memory and one or more processors. The one or more processors may be configured to, based at least in part on information stored in the memory, receive one or more of a capability of the mobile station or a location of the mobile station. The one or more processors may be configured to transmit an indication of one or more of a primary carrier or a secondary carrier selected by the network entity based at least in part on the capability of the mobile station and the location of the mobile station.

Some aspects described herein relate to a non-transitory computer-readable medium that stores a set of instructions for wireless communication by a first mobile station. The set of instructions, when executed by one or more processors of the first mobile station, may cause the first mobile station to transmit a signal on each of multiple sidelink carriers. The set of instructions, when executed by one or more processors of the first mobile station, may cause the first mobile station to receive one or more signals on one or more of the multiple sidelink carriers. The set of instructions, when executed by one or more processors of the first mobile station, may cause the first mobile station to select a primary carrier among the multiple sidelink carriers and a secondary carrier among the multiple sidelink carriers based at least in part on the one or more signals received on the one or more of the multiple sidelink carriers. The set of instructions, when executed by one or more processors of the first mobile station, may cause the first mobile station to negotiate which of the multiple sidelink carriers are to be an agreed primary carrier and an agreed secondary carrier.

Some aspects described herein relate to a non-transitory computer-readable medium that stores a set of instructions for wireless communication by a network entity. The set of instructions, when executed by one or more processors of the network entity, may cause the network entity to receive one or more of a capability of the mobile station or a location of the mobile station. The set of instructions, when executed by one or more processors of the network entity, may cause the network entity to transmit an indication of one or more of a primary carrier or a secondary carrier selected by the network entity based at least in part on the capability of the mobile station and the location of the mobile station.

Some aspects described herein relate to an apparatus for wireless communication. The apparatus may include means for transmitting a signal on each of multiple sidelink carriers. The apparatus may include means for receiving one or more signals on one or more of the multiple sidelink carriers. The apparatus may include means for selecting a primary carrier among the multiple sidelink carriers and a secondary carrier among the multiple sidelink carriers based at least in part on the one or more signals received on the one or more of the multiple sidelink carriers. The apparatus may include means for negotiating which of the multiple sidelink carriers are to be an agreed primary carrier and an agreed secondary carrier.

Some aspects described herein relate to an apparatus for wireless communication. The apparatus may include means for receiving one or more of a capability of the mobile station or a location of the mobile station. The apparatus may include means for transmitting an indication of one or more of a primary carrier or a secondary carrier selected by the apparatus based at least in part on the capability of the mobile station and the location of the mobile station.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of sidelink communications, in accordance with the present disclosure.

FIG. 4 is a diagram illustrating an example of sidelink communications and access link communications, in accordance with the present disclosure.

FIG. 5 is a diagram illustrating an example of carrier aggregation for sidelink, in accordance with the present disclosure.

FIG. 6 is a diagram illustrating an example associated with negotiating a primary carrier and a secondary carrier in sidelink, in accordance with the present disclosure.

FIG. 7 is a diagram illustrating an example of carrier configuration for connection-based groupcast, in accordance with the present disclosure.

FIG. 8 is a diagram illustrating an example of carrier configuration for connection-less groupcast, in accordance with the present disclosure.

FIG. 9 is a diagram illustrating an example process performed, for example, by a first mobile station, in accordance with the present disclosure.

FIG. 10 is a diagram illustrating an example process performed, for example, by a network entity, in accordance with the present disclosure.

FIGS. 11-12 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

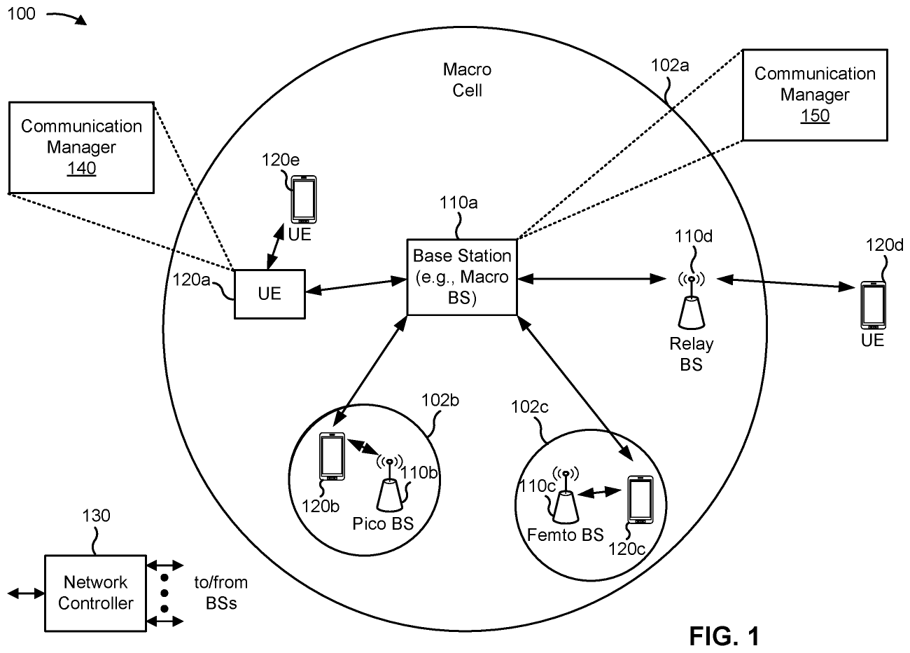

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A UE may also be referred to a “mobile station”. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), a roadside unit (RSU), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, RSUs, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a first mobile station (e.g., UE 120) may include a communication manager 140. As described in more detail elsewhere herein, the communication manager 140 may transmit a signal on each of multiple sidelink carriers and receive one or more signals on one or more of the multiple sidelink carriers. The communication manager 140 may select a primary carrier among the multiple sidelink carriers and a secondary carrier among the multiple sidelink carriers based at least in part on the one or more signals received on the one or more of the multiple sidelink carriers and negotiate which of the multiple sidelink carriers are to be an agreed primary carrier and an agreed secondary carrier. Additionally, or alternatively, the communication manager 140 may perform one or more other operations described herein.

In some aspects, a network entity (e.g., base station 110) may include a communication manager 150. As described in more detail elsewhere herein, the communication manager 150 may receive one or more of a capability of the mobile station or a location of the mobile station and transmit an indication of one or more of a primary carrier or a secondary carrier selected by the network entity based at least in part on the capability of the mobile station and the location of the mobile station. Additionally, or alternatively, the communication manager 150 may perform one or more other operations described herein.

As indicated above, FIG. 1 is provided as an example. Other examples may differ from what is described with regard to FIG. 1.

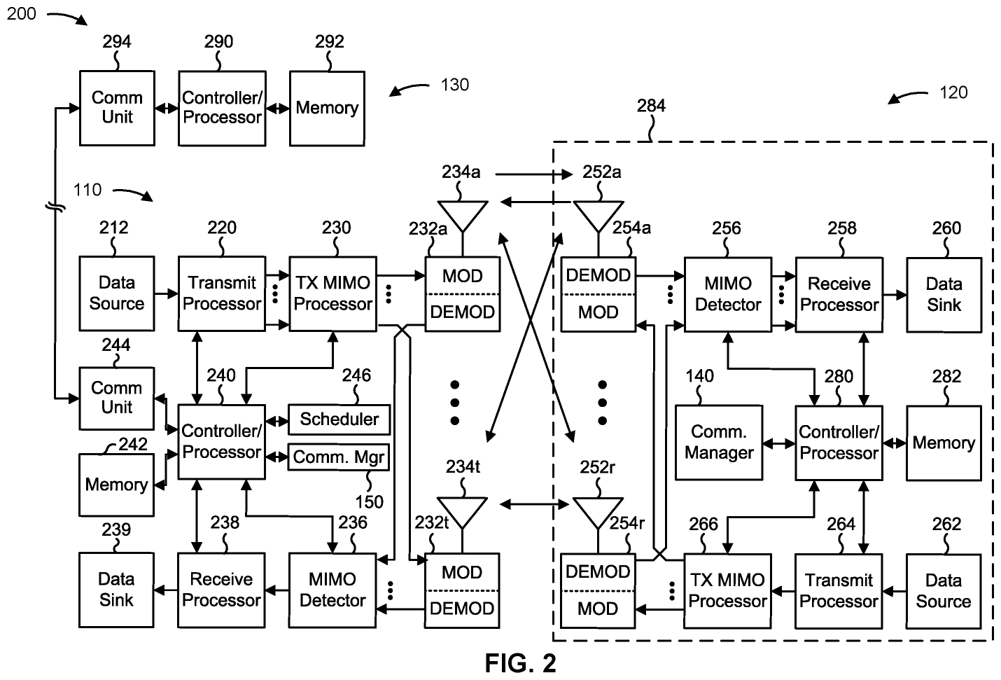

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

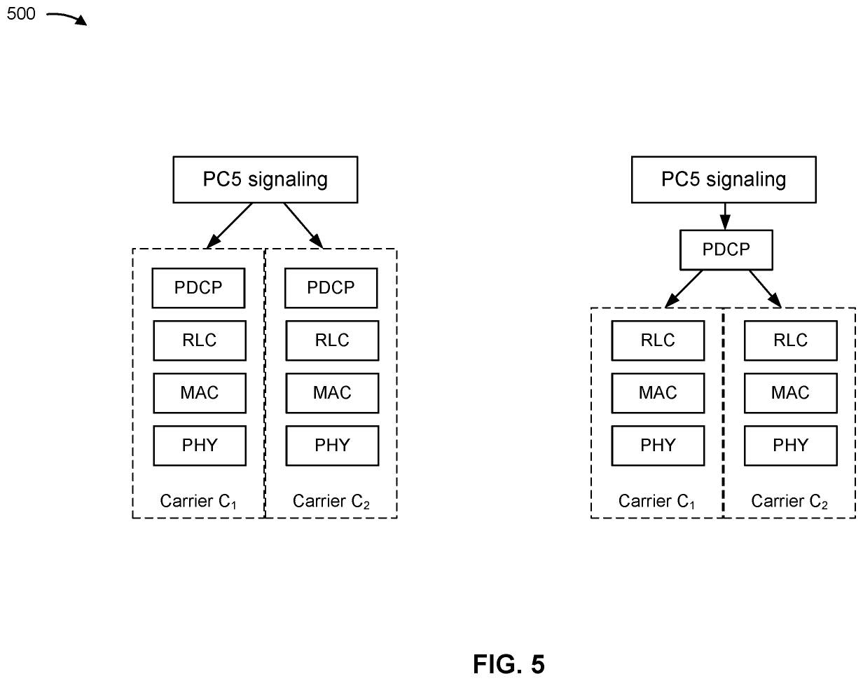

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-12).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-12).

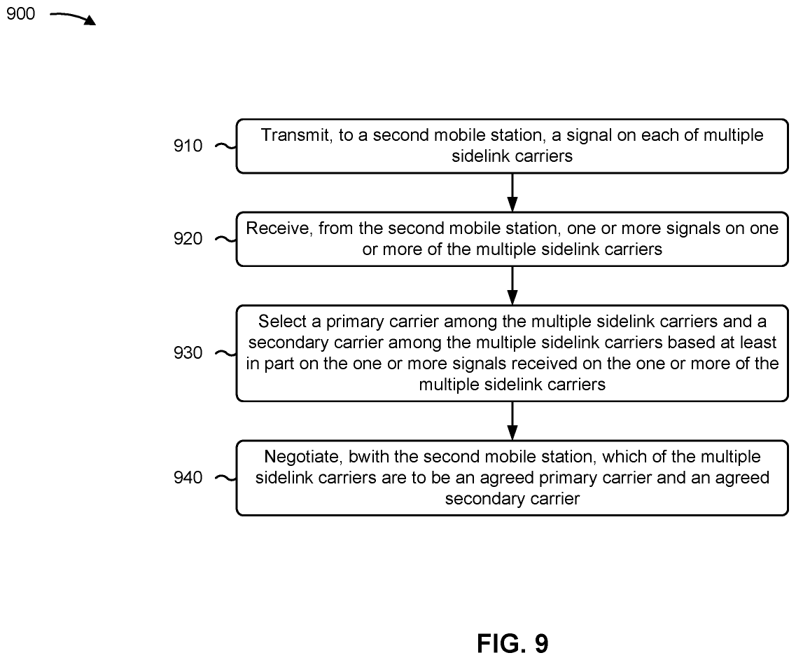

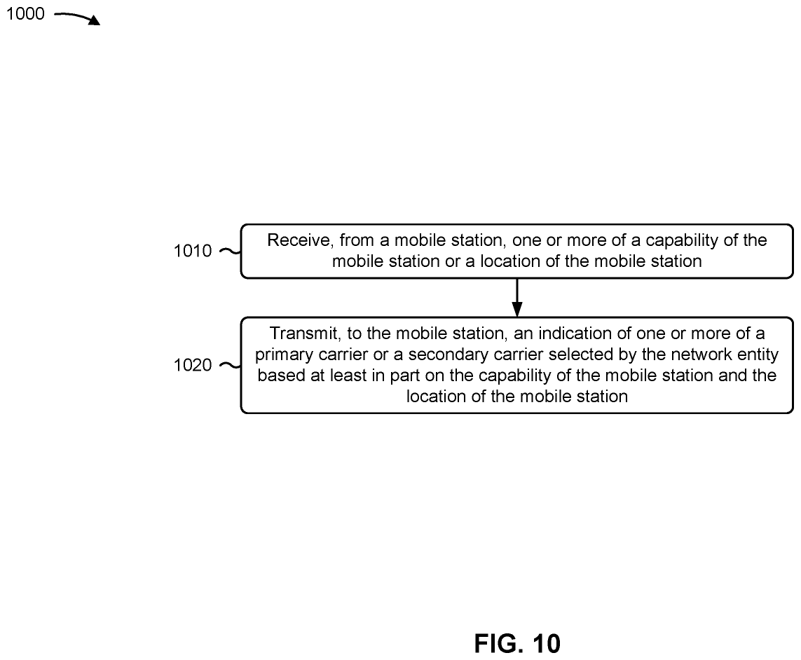

The controller/processor 240 of the base station 110, the controller/processor 280 of the UE 120, and/or any other component(s) of FIG. 2 may perform one or more techniques associated with negotiating a primary carrier and a secondary carrier, as described in more detail elsewhere herein. For example, the controller/processor 240 of the base station 110, the controller/processor 280 of the UE 120, and/or any other component(s) of FIG. 2 may perform or direct operations of, for example, process 900 of FIG. 9, process 1000 of FIG. 10, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 900 of FIG. 9, process 1000 of FIG. 10, and/or other processes as described herein. In some examples, executing instructions may include running the instructions, converting the instructions, compiling the instructions, and/or interpreting the instructions, among other examples.

In some aspects, a first mobile station (e.g., UE 120) includes means for transmitting, by the first mobile station to a second mobile station, a signal on each of multiple sidelink carriers; means for receiving, by the first mobile station from the second mobile station, one or more signals on one or more of the multiple sidelink carriers; means for selecting, by the first mobile station, a primary carrier among the multiple sidelink carriers and a secondary carrier among the multiple sidelink carriers based at least in part on the one or more signals received on the one or more of the multiple sidelink carriers; and/or means for negotiating, by the first mobile station with the second mobile station, which of the multiple sidelink carriers are to be an agreed primary carrier and an agreed secondary carrier. In some aspects, the means for the first mobile station to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network entity (e.g., base station 110) includes means for receiving, by the network entity from a mobile station, one or more of a capability of the mobile station or a location of the mobile station; and/or means for transmitting, by the network entity to the mobile station, an indication of one or more of a primary carrier or a secondary carrier selected by the network entity based at least in part on the capability of the mobile station and the location of the mobile station. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

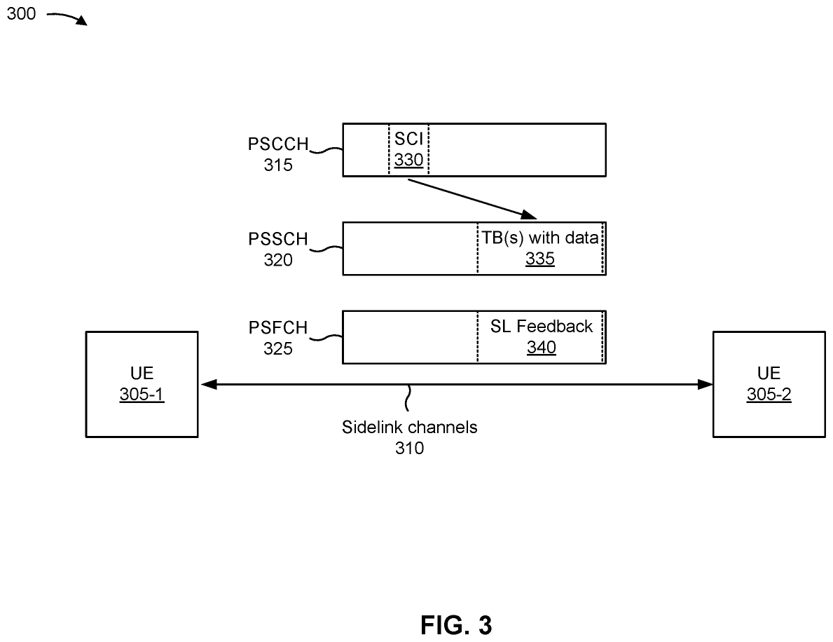

FIG. 3 is a diagram illustrating an example 300 of sidelink communications, in accordance with the present disclosure.

As shown in FIG. 3, a first UE 305-1 may communicate with a second UE 305-2 (and one or more other UEs 305) via one or more sidelink channels 310. The UEs 305-1 and 305-2 may communicate using the one or more sidelink channels 310 for P2P communications, D2D communications, V2X communications (e.g., which may include V2V communications, V2I communications, and/or V2P communications) and/or mesh networking. In some aspects, the UEs 305 (e.g., UE 305-1 and/or UE 305-2) may correspond to one or more other UEs described elsewhere herein, such as UE 120. In some aspects, the one or more sidelink channels 310 may use a PC5 interface and/or may operate in a high frequency band (e.g., the 5.9 GHz band). Additionally, or alternatively, the UEs 305 may synchronize timing of transmission time intervals (TTIs) (e.g., frames, subframes, slots, or symbols) using global navigation satellite system (GNSS) timing.

As further shown in FIG. 3, the one or more sidelink channels 310 may include a physical sidelink control channel (PSCCH) 315, a physical sidelink shared channel (PSSCH) 320, and/or a physical sidelink feedback channel (PSFCH) 325. The PSCCH 315 may be used to communicate control information, similar to a physical downlink control channel (PDCCH) and/or a physical uplink control channel (PUCCH) used for cellular communications with a base station 110 via an access link or an access channel. The PSSCH 320 may be used to communicate data, similar to a physical downlink shared channel (PDSCH) and/or a physical uplink shared channel (PUSCH) used for cellular communications with a base station 110 via an access link or an access channel. For example, the PSCCH 315 may carry sidelink control information (SCI) 330, which may indicate various control information used for sidelink communications, such as one or more resources (e.g., time resources, frequency resources, and/or spatial resources) where a transport block (TB) 335 may be carried on the PSSCH 320. The TB 335 may include data. The PSFCH 325 may be used to communicate sidelink feedback 340, such as hybrid automatic repeat request (HARQ) feedback (e.g., acknowledgement or negative acknowledgement (ACK/NACK) information), transmit power control (TPC), and/or a scheduling request (SR).

Although shown on the PSCCH 315, in some aspects, the SCI 330 may include multiple communications in different stages, such as a first stage SCI (SCI-1) and a second stage SCI (SCI-2). The SCI-1 may be transmitted on the PSCCH 315. The SCI-2 may be transmitted on the PSSCH 320. The SCI-1 may include, for example, an indication of one or more resources (e.g., time resources, frequency resources, and/or spatial resources) on the PSSCH 320, information for decoding sidelink communications on the PSSCH, a quality of service (QoS) priority value, a resource reservation period, a PSSCH DMRS pattern, an SCI format for the SCI-2, a beta offset for the SCI-2, a quantity of PSSCH DMRS ports, and/or an MCS. The SCI-2 may include information associated with data transmissions on the PSSCH 320, such as a HARQ process identifier (ID), a new data indicator (NDI), a source identifier, a destination identifier, and/or a channel state information (CSI) report trigger.

In some aspects, the one or more sidelink channels 310 may use resource pools. For example, a scheduling assignment (e.g., included in SCI 330) may be transmitted in sub-channels using specific resource blocks (RBs) across time. In some aspects, data transmissions (e.g., on the PSSCH 320) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 305 may operate using a sidelink transmission mode (e.g., Mode 1) where resource selection and/or scheduling is performed by a base station 110. For example, the UE 305 may receive a grant (e.g., in downlink control information (DCI) or in a radio resource control (RRC) message, such as for configured grants) from the base station 110 for sidelink channel access and/or scheduling. In some aspects, a UE 305 may operate using a transmission mode (e.g., Mode 2) where resource selection and/or scheduling is performed by the UE 305 (e.g., rather than a base station 110). In some aspects, the UE 305 may perform resource selection and/or scheduling by sensing channel availability for transmissions. For example, the UE 305 may measure an RSSI parameter (e.g., a sidelink-RSSI (S-RSSI) parameter) associated with various sidelink channels, may measure an RSRP parameter (e.g., a PSSCH-RSRP parameter) associated with various sidelink channels, and/or may measure an RSRQ parameter (e.g., a PSSCH-RSRQ parameter) associated with various sidelink channels, and may select a channel for transmission of a sidelink communication based at least in part on the measurement(s).

Additionally, or alternatively, the UE 305 may perform resource selection and/or scheduling using SCI 330 received in the PSCCH 315, which may indicate occupied resources and/or channel parameters. Additionally, or alternatively, the UE 305 may perform resource selection and/or scheduling by determining a channel busy rate (CBR) associated with various sidelink channels, which may be used for rate control (e.g., by indicating a maximum number of resource blocks that the UE 305 can use for a particular set of subframes).

In the transmission mode where resource selection and/or scheduling is performed by a UE 305, the UE 305 may generate sidelink grants, and may transmit the grants in SCI 330. A sidelink grant may indicate, for example, one or more parameters (e.g., transmission parameters) to be used for an upcoming sidelink transmission, such as one or more resource blocks to be used for the upcoming sidelink transmission on the PSSCH 320 (e.g., for TBs 335), one or more subframes to be used for the upcoming sidelink transmission, and/or an MCS to be used for the upcoming sidelink transmission. In some aspects, a UE 305 may generate a sidelink grant that indicates one or more parameters for semi-persistent scheduling (SPS), such as a periodicity of a sidelink transmission. Additionally, or alternatively, the UE 305 may generate a sidelink grant for event-driven scheduling, such as for an on-demand sidelink message.

As indicated above, FIG. 3 is provided as an example. Other examples may differ from what is described with respect to FIG. 3.

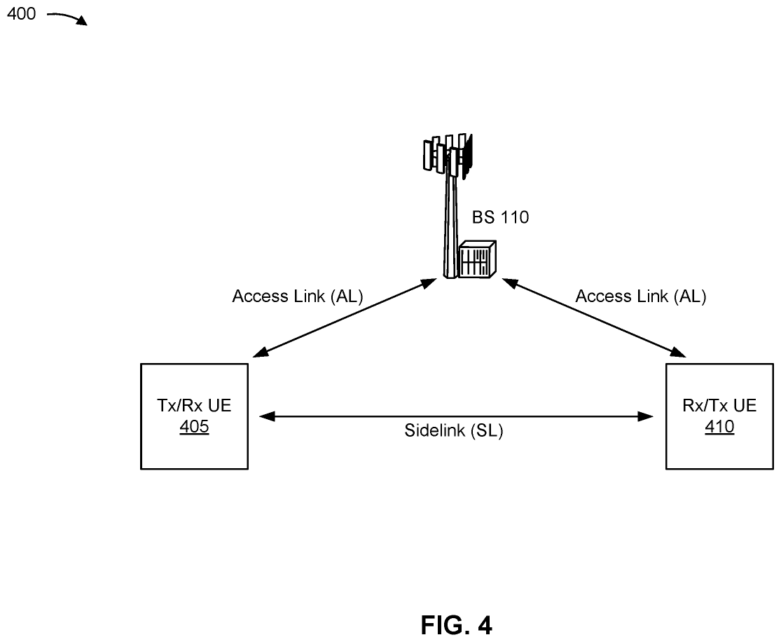

FIG. 4 is a diagram illustrating an example 400 of sidelink communications and access link communications, in accordance with the present disclosure.

As shown in FIG. 4, a transmitter (Tx)/receiver (Rx) UE 405 and an Rx/Tx UE 410 may communicate with one another via a sidelink, as described above in connection with FIG. 3. As further shown, in some sidelink modes, a base station 110 may communicate with the Tx/Rx UE 405 via a first access link. Additionally, or alternatively, in some sidelink modes, the base station 110 may communicate with the Rx/Tx UE 410 via a second access link. The Tx/Rx UE 405 and/or the Rx/Tx UE 410 may correspond to one or more UEs described elsewhere herein, such as the UE 120 of FIG. 1. Thus, a direct link between UEs 120 (e.g., via a PC5 interface) may be referred to as a sidelink, and a direct link between a base station 110 and a UE 120 (e.g., via a Uu interface) may be referred to as an access link. Sidelink communications may be transmitted via the sidelink, and access link communications may be transmitted via the access link. An access link communication may be either a downlink communication (from a base station 110 to a UE 120) or an uplink communication (from a UE 120 to a base station 110).

As indicated above, FIG. 4 is provided as an example. Other examples may differ from what is described with respect to FIG. 4.

FIG. 5 is a diagram illustrating an example 500 of carrier aggregation (CA) for sidelink, in accordance with the present disclosure.

In CA, two or more carriers are used concurrently to improve the capacity of an uplink or downlink system. CA may be used in sidelink to enable high bandwidth applications, such as V2X applications that use sensor sharing and data sharing for a camera, a radar, or light detection and ranging (LIDAR). Higher layers of a UE may map an application to one or more carriers. However, UEs may different capabilities for CA or no CA capability. UEs may also support different sets of carriers. For example, a first UE (UE1) may support carriers {C₁, C₂, . . . Cₙ}, while a second UE (UE2) and a third UE (UE3) may support {D₁, D₂, . . . Dₘ}.

UE1 may transmit discovery messages in all of its supported carriers. As shown by example 500, each supported carrier may have its own protocol stack. The transmission of discovery messages may involve duplicating a signaling radio bearer (SRB) on the supported carriers. For example, a first SRB (SRB0) and a second SRB (SRB1) may be used to transport RRC messages. PC5-S and PCF-D sidelink signaling may be used at higher layers and signaling messages may be duplicated above a packet data convergence protocol (PDCP) layer, at the PDCP layer, or at a medium access control (MAC) layer. Sidelink data channel blocks (e.g., fixed size of 232 bits) may be mapped to a physical sidelink discovery channel (PSDCH) at a physical (PHY) layer. Each carrier may be preconfigured with a reception pool where a UE searches for the PSDCH.

In an example, UE1 may support carriers {C₁, C₂, C₃}, and UE2 may support carriers {C₁, C₃, C₄}. UE1 may transmit a signal on a PSDCH (or the equivalent PSCCH) in a preconfigured transmission/reception pool in every carrier of {C₁, C₂, C₃}, while UE2 performs the same for carriers {C₁, C₃, C₄}. UE1 may receive a Layer 1 (L1) or Layer 2 (L2) ID of UE2 in {C₁, C₃}, UE2 may receive a L1 or L2 ID of UE1 in {C₁, C₃}. That is, UE1 and UE2 may have common supported carriers {C₁, C₃}. UE1 and/or UE2 may initiate an RRC connection request in any of the common carriers {C₁, C₃}.

According to various aspects described herein, UE1 and UE2 may negotiate and agree on which carrier (e.g., C₁) is to be an agreed primary carrier and which carrier (e.g., C₃) is to be an agreed secondary carrier. By negotiating the primary carrier and the secondary carrier, UE1 and UE2 may more effectively use multiple carriers in CA scenarios and conserve processing resources that would otherwise be wasted on less than optimal carrier selection.

As indicated above, FIG. 5 is provided as an example. Other examples may differ from what is described with regard to FIG. 5.

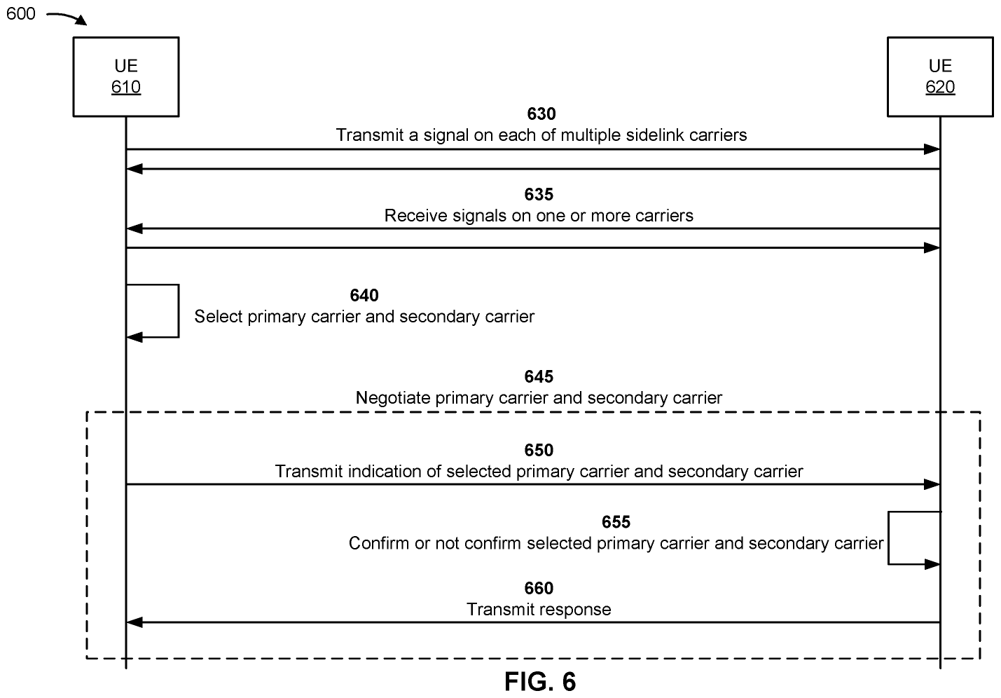

FIG. 6 is a diagram illustrating an example 600 associated with negotiating a primary carrier and a secondary carrier in sidelink, in accordance with the present disclosure. As shown in FIG. 6, a first UE 610 (e.g., a UE 120) and a second UE 620 (e.g., a UE 120) may communicate with one another.

As shown by reference number 630, UE 610 and UE 620 may each transmit a signal on each of multiple sidelink carriers. For example, UE 610 may transmit a reference signal on each of carriers {C₁, C₂, C₃}, and UE 620 may transmit a reference signal on each of carriers {C₁, C₃, C₄}. As shown by reference number 635, UE 610 and UE 620 may receive one or more signals on one or more of the multiple sidelink carriers. For example, UE 610 and UE 620 may both receive signals on carriers and UE 620 may each transmit a reference signal on each of carriers {C₁, C₃}. That is, UE 610 and UE 620 may each support carriers {C₁, C₃}.

As shown by reference number 640, UE 610 may select a primary carrier and a secondary carrier from among the supported carriers. For example, UE 610 may select C₁ to be a primary carrier and C₃ to be a secondary carrier. UE 610 may select the primary carrier and the secondary carrier based at least in part on measurements of the signals. If C₁ has a better RSRP, RSRQ, or error rate than C₂, UE 610 may select C₁ to be the primary carrier and C₂ to be the secondary carrier.

As shown by reference number 645, UE 610 and UE 620 may negotiate with each other as to which of the commonly supported carriers are to be the primary carrier and the secondary carrier. This may involve UE 610 transmitting an indication of the primary carrier and the secondary carrier selected by UE 610, as shown by reference number 650. UE 620 may also perform measurements of reference signals on the supported carriers and select the carrier that is to be the primary carrier and the carrier that is to be the secondary carrier. As shown by reference number 655, UE 620 may confirm (agree) or not confirm (reject or disagree) with the primary carrier and the secondary carrier selected by UE 610. As shown by reference number 660, UE 620 may transmit the response, whether the response confirms the selections of UE 610 or does not confirm the selections of UE 610. In some aspects, UE 620 may transmit, as a suggestion, an indication of the selection of the primary carrier and the secondary carrier by UE 620. UE 610 may agree with the primary carrier and the secondary carrier suggested by UE 620. UE 610 may transmit another message indicating if any agreement has been reached. Other suggestions and decisions may take place. Some rules may be used for stalemates. Once UE 610 and UE 620 agree on a primary carrier and a secondary carrier, UE 610 and UE 620 may perform an RRC reconfiguration procedure to update the primary carrier and the secondary carrier.

In some aspects, the negotiation may be based at least in part on a CBR for each of the commonly supported carriers. There may be a predetermined rule to select, as the primary carrier, the carrier that has the lowest CBR. If UE 610 and UE 620 agree to a primary carrier and a secondary carrier, UE 610 and UE 620 may transmit and receive sidelink communications on the agreed primary carrier and the agreed secondary carrier.

The sidelink communications may be unicast. In some aspects, UE 610 and UE 620 may route a data radio bearer (DRB) only on the secondary carrier and route one or more SRBs across all of the commonly supported carriers. In some aspects, based at least in part on a CBR reported on the MAC layer, UE 610 and UE 620 may duplicate DRBs and SRBs across all of the commonly supported carriers. The DRBs and SRBs may be duplicated if a CBR satisfies a threshold, such as meeting or exceeding a minimum CBR.

In some aspects, control channel transmission on the PHY layer may be based at least in part on control information (SCI-1/SCI-2) on the PSCCH and data on the PSSCH transmitted independently per carrier. In some aspects, control information may be transmitted in the primary carrier, while data is transmitted in the secondary carrier. Each SCI-1/SCI-2 may explicitly indicate which carrier and subchannel maps to the control information. For example, if C₁ is the primary carrier and C₃ is the secondary carrier, UE 610 and UE 620 may transmit control information in a subchannel in C₁ that maps to the data transmitted in a subchannel in C₃. This mapping may be explicitly indicated or preconfigured.

In some aspects, a MAC layer or a PHY layer may determine that a packet is to be duplicated based on a priority of the packet, in addition to the CBR in each of the carriers. UE 610 and UE 620 may use stored information, such as a table indicating different priority values and CBRs, to indicate when the packet is to be duplicated.

As indicated above, FIG. 6 is provided as an example. Other examples may differ from what is described with respect to FIG. 6.

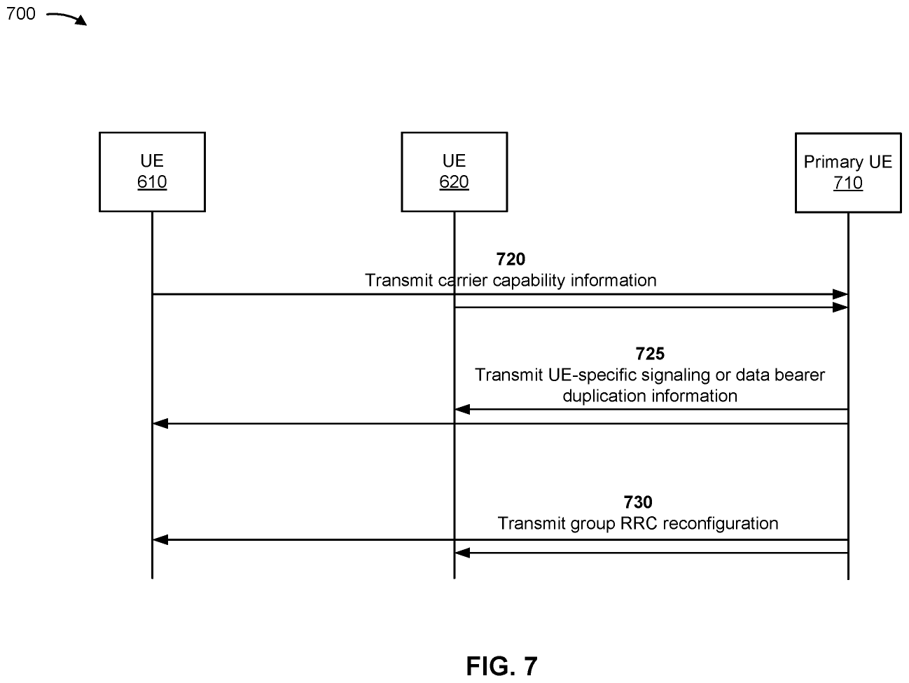

FIG. 7 is a diagram illustrating an example 700 of carrier configuration for connection-based groupcast, in accordance with the present disclosure. Example 700 shows a primary (master) UE 710 that may communicate with UE 610 and UE 620.

UE 610, UE 620, and primary UE 710 may be part of a group of UEs. Application layer procedures may be used to select primary UE 710 to be the primary UE and to coordinate primary carrier and secondary carrier information and radio bearer duplication. In example 700, the V2X layer of primary UE 710 may determine a carrier capability of all UEs in the group, by having each of the UEs provide a carrier capability to primary UE 710, as shown by reference number 720. In one example, primary UE 710 may select the primary carrier based at least in part on the UE with the lowest carrier capability in the group. In this way, each UE is able to communicate in the group.

As shown by reference number 725, primary UE 710 may provide a configuration to UEs in the group that may be UE-specific. For example, primary UE 710 may provide information about which radio bearers (a DRB, SRB0, SRB1) need to be duplicated across which carriers. For example, UE 610 may be able to transmit in carriers {C₁, C₂, C₃} and may receive a request to duplicate SRB0, SRB1 across C₁ and C₂ and provide the DRB across C₂.

In some aspects, as shown by reference number 730, primary UE 710 may use a group-specific configuration, such as a group RRC reconfiguration, to update primary and secondary carrier information and to update SRB/DRB duplication information, when UEs join the group, or when UEs leave the group.

When all UEs in the group have two or more common subcarriers, primary UE 710 may reconfigure one feedback channel per carrier or provide for feedback in only one of the common carriers. For example, primary UE 710 may configure the feedback for carriers {C₂, C₃} (where carriers {C₂, C₃} can be supported by all UEs in the group) to be provided in C₂ or C₃. In example 700, every other feedback symbol may be used as a PSFCH resource. The first PSFCH instance may be assigned to C₂, the second PSFCH instance may be assigned to C₂, and so forth.

As indicated above, FIG. 7 is provided as an example. Other examples may differ from what is described with regard to FIG. 7.

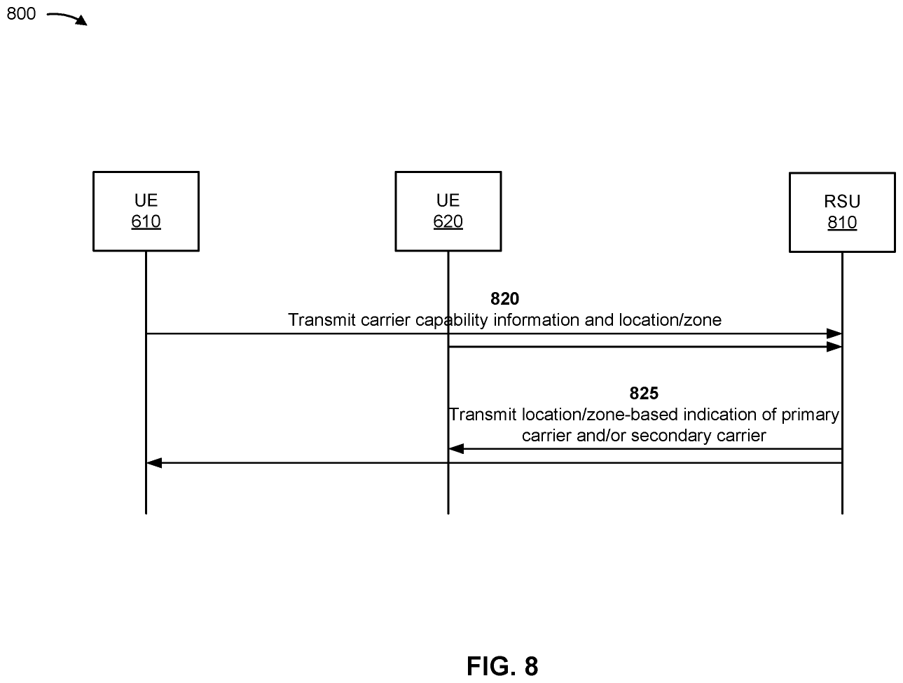

FIG. 8 is a diagram illustrating an example 800 of carrier configuration for connection-less groupcast, in accordance with the present disclosure. Example 800 shows a network entity (e.g., RSU 810) that may communicate with UE 610 and UE 620.

As shown by reference number 820, UE 610 and UE 620 may transmit carrier capability information to the RSU 810. In some aspects, RSU 810 (or a UE in the group), may create a mapping between an application (e.g., provider service identifier (PSID)) and the carriers that a UE can use for transmission. For example, PSID1 may be mapped to carriers {C₁, C₂}, and PSID2 may be mapped to carriers {C₂, C₃}.

In some aspects, if a UE is using PSID1, this means that the UE is capable of using carriers {C₁, C₂}. That is, PSID1 cannot be used by a UE unless the UE supports all of the carriers associated with the application. A preconfigured primary carrier and secondary carrier can be assigned. Alternatively, the mapping between the application, and the carriers may simply indicate the allowable carrier transmissions. That is, a UE need not support all carriers associated with the application. In this alternative scenario, a universal primary and secondary carrier configuration may not be assigned.

In some aspects, the RSU 810 may consider a location of a UE (e.g., zone containing the UE) for carrier selection. As shown by reference number 820, UE 610 and UE 620 may each transmit an indication of a carrier capability and a location or zone. The RSU 810 may select a primary carrier and/or a secondary carrier based at least in part on the capabilities reported by UE 610 and UE 620 and further based at least in part on the location or zone of the UEs. As shown by reference number 825, the RSU 810 may transmit an indication of the primary carrier and/or the secondary carrier. While example 800 shows the network entity to be an RSU, the network entity may also be a gNB.

As indicated above, FIG. 8 is provided as an example. Other examples may differ from what is described with regard to FIG. 8.

FIG. 9 is a diagram illustrating an example process 900 performed, for example, by a first mobile station, in accordance with the present disclosure. Example process 900 is an example where the first mobile station (e.g., a UE 120, UE 610, UE 620, primary UE 710) performs operations associated with primary carrier and secondary carrier negotiation.

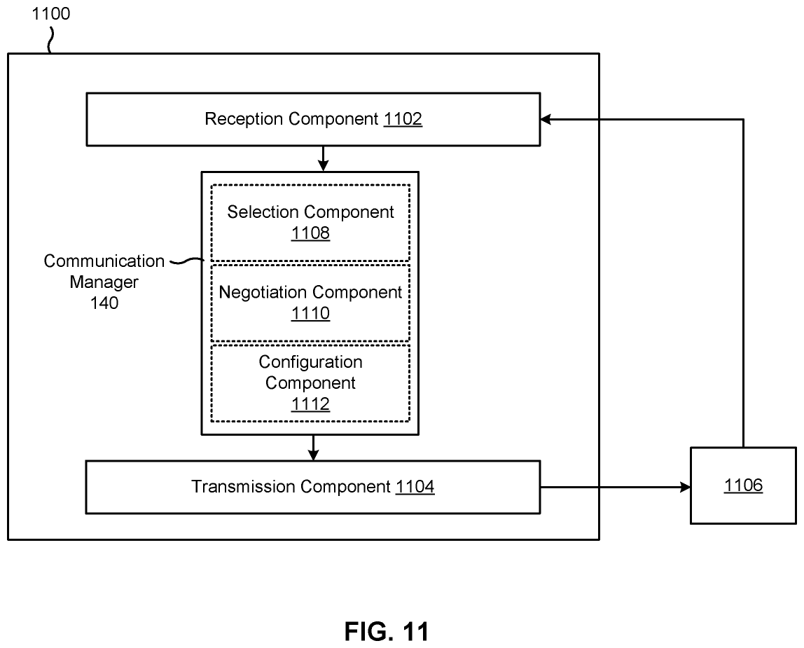

As shown in FIG. 9, in some aspects, process 900 may include transmitting a signal on each of multiple sidelink carriers (block 910). For example, the first mobile station (e.g., using communication manager 140 and/or transmission component 1104 depicted in FIG. 11) may transmit a signal on each of multiple sidelink carriers, as described above.

As further shown in FIG. 9, in some aspects, process 900 may include receiving one or more signals on one or more of the multiple sidelink carriers (block 920). For example, the first mobile station (e.g., using communication manager 140 and/or reception component 1102 depicted in FIG. 11) may receive one or more signals on one or more of the multiple sidelink carriers, as described above.

As further shown in FIG. 9, in some aspects, process 900 may include selecting a primary carrier among the multiple sidelink carriers and a secondary carrier among the multiple sidelink carriers based at least in part on the one or more signals received on the one or more of the multiple sidelink carriers (block 930). For example, the first mobile station (e.g., using communication manager 140 and/or selection component 1108 depicted in FIG. 11) may select a primary carrier among the multiple sidelink carriers and a secondary carrier among the multiple sidelink carriers based at least in part on the one or more signals received on the one or more of the multiple sidelink carriers, as described above.

As further shown in FIG. 9, in some aspects, process 900 may include negotiating which of the multiple sidelink carriers are to be an agreed primary carrier and an agreed secondary carrier (block 940). For example, the first mobile station (e.g., using communication manager 140 and/or negotiation component 1110, depicted in FIG. 11) may negotiate which of the multiple sidelink carriers are to be an agreed primary carrier and an agreed secondary carrier, as described above.

Process 900 may include additional aspects, such as any single aspect or any combination of aspects described below and/or in connection with one or more other processes described elsewhere herein.

In a first aspect, negotiating which of the multiple sidelink carriers are to be the agreed primary carrier and the agreed secondary carrier comprises transmitting an indication of the primary carrier and the secondary carrier selected by the first mobile station, and receiving a response to the indication, indicating that the second mobile station confirms the primary carrier and the secondary carrier selected by the first mobile station.

In a second aspect, alone or in combination with the first aspect, negotiating which of the multiple sidelink carriers are to be the agreed primary carrier and the agreed secondary carrier comprises transmitting an indication of the primary carrier and the secondary carrier selected by the first mobile station, and receiving a response to the indication, indicating that the second mobile station does not confirm the primary carrier and the secondary carrier selected by the first mobile station.

In a third aspect, alone or in combination with one or more of the first and second aspects, the response indicates a selection of a primary carrier and a secondary carrier by the second mobile station.

In a fourth aspect, alone or in combination with one or more of the first through third aspects, negotiating which of the multiple sidelink carriers are to be the agreed primary carrier and the agreed secondary carrier comprises receiving an indication of a primary carrier and a secondary carrier selected by the second mobile station, generating a response to the indication based at least in part on the selecting of the primary carrier and the secondary carrier by the first mobile station, and transmitting the response.

In a fifth aspect, alone or in combination with one or more of the first through fourth aspects, the response confirms the selection of the primary carrier and the secondary carrier by the second mobile station as the agreed primary carrier and the agreed secondary carrier.

In a sixth aspect, alone or in combination with one or more of the first through fifth aspects, the response rejects the selection of the primary carrier and the secondary carrier by the second mobile station.

In a seventh aspect, alone or in combination with one or more of the first through sixth aspects, the response suggests the primary carrier and the secondary carrier selected by the first mobile station for the agreed primary carrier and the agreed secondary carrier.

In an eighth aspect, alone or in combination with one or more of the first through seventh aspects, process 900 includes routing a DRB only to the agreed secondary carrier and duplicating an SRB on all carriers of the multiple sidelink carriers.

In a ninth aspect, alone or in combination with one or more of the first through eighth aspects, process 900 includes duplicating a DRB and an SRB across all of the multiple sidelink carriers based at least in part on a channel busy ratio for the multiple sidelink carriers.

In a tenth aspect, alone or in combination with one or more of the first through ninth aspects, the negotiating is further based at least in part on a CBR for the multiple sidelink carriers.

In an eleventh aspect, alone or in combination with one or more of the first through tenth aspects, process 900 includes transmitting duplicates of a packet on one or more of the agreed primary carrier or the agreed secondary carrier based at least in part on a priority of the packet.

In a twelfth aspect, alone or in combination with one or more of the first through eleventh aspects, the agreed primary carrier and the agreed secondary carrier are for unicast communication, and process 900 includes transmitting control information and data independently per carrier.

In a thirteenth aspect, alone or in combination with one or more of the first through twelfth aspects, the agreed primary carrier and the agreed secondary carrier are for unicast communications, and process 900 includes transmitting control information on the primary carrier and data on the secondary carrier.

In a fourteenth aspect, alone or in combination with one or more of the first through thirteenth aspects, the agreed primary carrier and the agreed secondary carrier are for connection-based groupcast communications, and process 900 includes determining a carrier capability of other mobile stations in a group of mobile stations that includes the first mobile station, based at least in part on capability information received from each of the other mobile stations.

In a fifteenth aspect, alone or in combination with one or more of the first through fourteenth aspects, process 900 includes transmitting an indication of radio bearers that are to be duplicated on one or more carriers of the multiple sidelink carriers.

In a sixteenth aspect, alone or in combination with one or more of the first through fifteenth aspects, process 900 includes transmitting an indication of a feedback channel per carrier or in a common carrier.

In a seventeenth aspect, alone or in combination with one or more of the first through sixteenth aspects, process 900 includes generating a mapping between an application and one or more of the multiple sidelink carriers.

In an eighteenth aspect, alone or in combination with one or more of the first through seventeenth aspects, process 900 includes assigning the agreed primary carrier and the agreed secondary carrier to the application if the application supports all of the multiple sidelink carriers.

In a nineteenth aspect, alone or in combination with one or more of the first through eighteenth aspects, the mapping indicates one or more supported carriers of the multiple sidelink carriers based at least in part on the application.

In a twentieth aspect, alone or in combination with one or more of the first through nineteenth aspects, process 900 includes transmitting, by the first mobile station to a network entity, one or more of a capability of the first mobile station or a location of the first mobile station, and receiving, by the first mobile station from the network entity, an indication of the agreed primary carrier.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a network entity, in accordance with the present disclosure. Example process 1000 is an example where the network entity (e.g., base station 110, RSU 810) performs operations associated with primary carrier and secondary carrier negotiation.

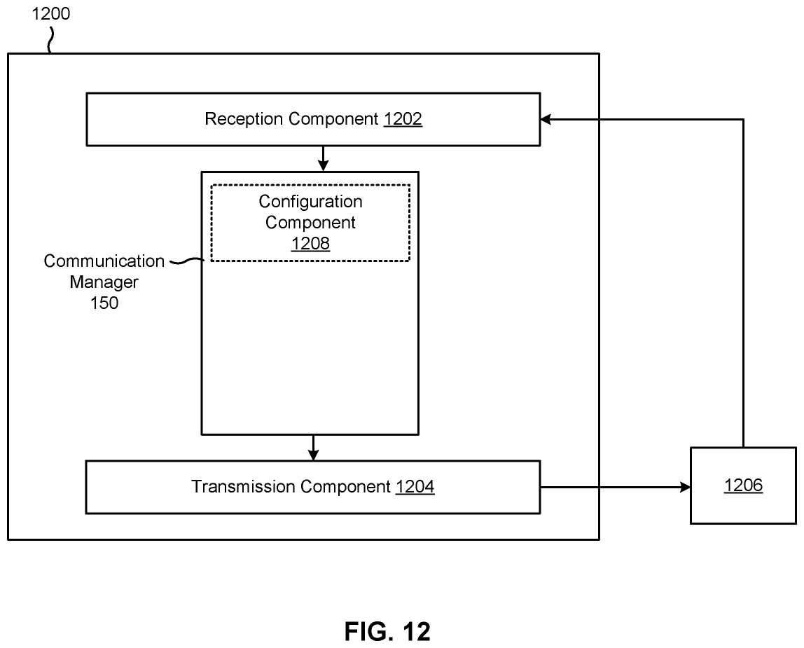

As shown in FIG. 10, in some aspects, process 1000 may include receiving one or more of a capability of the mobile station or a location of the mobile station (block 1010). For example, the network entity (e.g., using communication manager 150 and/or reception component 1202 depicted in FIG. 12) may receive one or more of a capability of the mobile station or a location of the mobile station, as described above.

As further shown in FIG. 10, in some aspects, process 1000 may include transmitting an indication of one or more of a primary carrier or a secondary carrier selected by the network entity based at least in part on the capability of the mobile station and the location of the mobile station (block 1020). For example, the network entity (e.g., using communication manager 150 and/or transmission component 1204 depicted in FIG. 12) may transmit an indication of one or more of a primary carrier or a secondary carrier selected by the network entity based at least in part on the capability of the mobile station and the location of the mobile station, as described above.

Process 1000 may include additional aspects, such as any single aspect or any combination of aspects described below and/or in connection with one or more other processes described elsewhere herein.

In a first aspect, the network entity is an RSU. In a second aspect, alone or in combination with the first aspect, the network entity is a base station.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication. The apparatus 1100 may be a first mobile station (e.g., a UE 120, UE 610, UE 620, primary UE 710), or a first mobile station may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, an RSU, or another wireless communication device) using the reception component 1102 and the transmission component 1104. As further shown, the apparatus 1100 may include the communication manager 140. The communication manager 140 may include a selection component 1108, a negotiation component 1110, and/or a configuration component 1112, among other examples.

In some aspects, the apparatus 1100 may be configured to perform one or more operations described herein in connection with FIGS. 1-8. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the first mobile station described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the first mobile station described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the first mobile station described in connection with FIG. 2. In some aspects, the transmission component 1104 may be co-located with the reception component 1102 in a transceiver.

The transmission component 1104 may transmit a signal on each of multiple sidelink carriers. The reception component 1102 may receive one or more signals on one or more of the multiple sidelink carriers. The selection component 1108 may select a primary carrier among the multiple sidelink carriers and a secondary carrier among the multiple sidelink carriers based at least in part on the one or more signals received on the one or more of the multiple sidelink carriers. The negotiation component 1110 may negotiate which of the multiple sidelink carriers are to be an agreed primary carrier and an agreed secondary carrier.

The configuration component 1112 may route a DRB only to the agreed secondary carrier and duplicating an SRB on all carriers of the multiple sidelink carriers. The configuration component 1112 may duplicate a DRB and an SRB across all of the multiple sidelink carriers based at least in part on a channel busy ratio for the multiple sidelink carriers.

The transmission component 1104 may transmit duplicates of a packet on one or more of the agreed primary carrier or the agreed secondary carrier based at least in part on a priority of the packet. The transmission component 1104 may transmit an indication of radio bearers that are to be duplicated on one or more carriers of the multiple sidelink carriers. The transmission component 1104 may transmit an indication of a feedback channel per carrier or in a common carrier.

The configuration component 1112 may generate a mapping between an application and one or more of the multiple sidelink carriers. The configuration component 1112 may assign the agreed primary carrier and the agreed secondary carrier to the application if the application supports all of the multiple sidelink carriers.

The transmission component 1104 may transmit one or more of a capability of the first mobile station or a location of the first mobile station. The reception component 1102 may receive an indication of the agreed primary carrier.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication. The apparatus 1200 may be a network entity (e.g., base station 110, RSU, or a network entity may include the apparatus 1200). In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include the communication manager 150. The communication manager 150 may include a configuration component 1208, among other examples.

In some aspects, the apparatus 1200 may be configured to perform one or more operations described herein in connection with FIGS. 1-8. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the network entity described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the network entity described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the network entity described in connection with FIG. 2. In some aspects, the transmission component 1204 may be co-located with the reception component 1202 in a transceiver.

The reception component 1202 may receive one or more of a capability of the mobile station or a location of the mobile station. The transmission component 1204 may transmit an indication of one or more of a primary carrier or a secondary carrier selected by the network entity based at least in part on the capability of the mobile station and the location of the mobile station. The configuration component 1208 may configure carriers for UEs.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a first mobile station, comprising: transmitting, by the first mobile station to a second mobile station, a signal on each of multiple sidelink carriers; receiving, by the first mobile station from the second mobile station, one or more signals on one or more of the multiple sidelink carriers; selecting, by the first mobile station, a primary carrier among the multiple sidelink carriers and a secondary carrier among the multiple sidelink carriers based at least in part on the one or more signals received on the one or more of the multiple sidelink carriers; and negotiating, by the first mobile station with the second mobile station, which of the multiple sidelink carriers are to be an agreed primary carrier and an agreed secondary carrier.

Aspect 2: The method of Aspect 1, wherein negotiating which of the multiple sidelink carriers are to be the agreed primary carrier and the agreed secondary carrier comprises: transmitting, by the first mobile station to the second mobile station, an indication of the primary carrier and the secondary carrier selected by the first mobile station; and receiving, by the first mobile station from the second mobile station, a response to the indication, indicating that the second mobile station confirms the primary carrier and the secondary carrier selected by the first mobile station.

Aspect 3: The method of Aspect 1, wherein negotiating which of the multiple sidelink carriers are to be the agreed primary carrier and the agreed secondary carrier comprises: transmitting, by the first mobile station to the second mobile station, an indication of the primary carrier and the secondary carrier selected by the first mobile station; and receiving, by the first mobile station from the second mobile station, a response to the indication, indicating that the second mobile station does not confirm the primary carrier and the secondary carrier selected by the first mobile station.

Aspect 4: The method of Aspect 3, wherein the response indicates a selection of a primary carrier and a secondary carrier by the second mobile station.

Aspect 5: The method of Aspect 1, wherein negotiating which of the multiple sidelink carriers are to be the agreed primary carrier and the agreed secondary carrier comprises: receiving, by the first mobile station from the second mobile station, an indication of a primary carrier and a secondary carrier selected by the second mobile station; generating a response to the indication based at least in part on the selecting of the primary carrier and the secondary carrier by the first mobile station; and transmitting, by the first mobile station to the second mobile station, the response.

Aspect 6: The method of Aspect 5, wherein the response confirms the selection of the primary carrier and the secondary carrier by the second mobile station as the agreed primary carrier and the agreed secondary carrier.

Aspect 7: The method of Aspect 5, wherein the response rejects the selection of the primary carrier and the secondary carrier by the second mobile station.

Aspect 8: The method of Aspect 7, wherein the response suggests the primary carrier and the secondary carrier selected by the first mobile station for the agreed primary carrier and the agreed secondary carrier.

Aspect 9: The method of any of Aspects 1-8, further comprising routing a data radio bearer only to the agreed secondary carrier and duplicating a signaling radio bearer on all carriers of the multiple sidelink carriers.

Aspect 10: The method of any of Aspects 1-8, further comprising duplicating a data radio bearer and a signaling radio bearer across all of the multiple sidelink carriers based at least in part on a channel busy ratio for the multiple sidelink carriers.

Aspect 11: The method of any of Aspects 1-10, wherein the negotiating is further based at least in part on a channel busy ratio for the multiple sidelink carriers.

Aspect 12: The method of Aspect 11, further comprising transmitting duplicates of a packet on one or more of the agreed primary carrier or the agreed secondary carrier based at least in part on a priority of the packet.

Aspect 13: The method of any of Aspects 1-12, wherein the agreed primary carrier and the agreed secondary carrier are for unicast communication, and wherein the method further comprises transmitting control information and data independently per carrier.

Aspect 14: The method of any of Aspects 1-12, wherein the agreed primary carrier and the agreed secondary carrier are for unicast communications, and wherein the method further comprises transmitting control information on the primary carrier and data on the secondary carrier.

Aspect 15: The method of any of Aspects 1-12, wherein the agreed primary carrier and the agreed secondary carrier are for connection-based groupcast communications, and wherein the method further comprises determining a carrier capability of other mobile stations in a group of mobile stations that includes the first mobile station, based at least in part on capability information received from each of the other mobile stations.

Aspect 16: The method of Aspect 15, further comprising transmitting an indication of radio bearers that are to be duplicated on one or more carriers of the multiple sidelink carriers.

Aspect 17: The method of Aspect 15 or 16, further comprising transmitting an indication of a feedback channel per carrier or in a common carrier.

Aspect 18: The method of any of Aspects 1-17, further comprising generating a mapping between an application and one or more of the multiple sidelink carriers.

Aspect 19: The method of Aspect 18, further comprising assigning the agreed primary carrier and the agreed secondary carrier to the application if the application supports all of the multiple sidelink carriers.

Aspect 20: The method of Aspect 18 or 19, wherein the mapping indicates one or more supported carriers of the multiple sidelink carriers based at least in part on the application.

Aspect 21: The method of any of Aspects 1-20, further comprising: transmitting, by the first mobile station to a network entity, one or more of a capability of the first mobile station or a location of the first mobile station; and receiving, by the first mobile station from the network entity, an indication of the agreed primary carrier.

Aspect 22: A method of wireless communication performed by a network entity, comprising: receiving, by the network entity from a mobile station, one or more of a capability of the mobile station or a location of the mobile station; and transmitting, by the network entity to the mobile station, an indication of one or more of a primary carrier or a secondary carrier selected by the network entity based at least in part on the capability of the mobile station and the location of the mobile station.

Aspect 23: The method of Aspect 22, wherein the network entity is a roadside unit.

Aspect 24: The method of Aspect 22, wherein the network entity is a base station.

Aspect 25: An apparatus for wireless communication at a device, comprising a processor; memory coupled with the processor; and instructions stored in the memory and executable by the processor to cause the apparatus to perform the method of one or more of Aspects 1-24.

Aspect 26: A device for wireless communication, comprising a memory and one or more processors configured to, based at least in part on information stored in the memory, perform the method of one or more of Aspects 1-24.

Aspect 27: An apparatus for wireless communication, comprising at least one means for performing the method of one or more of Aspects 1-24.

Aspect 28: A non-transitory computer-readable medium storing code for wireless communication, the code comprising instructions executable by a processor to perform the method of one or more of Aspects 1-24.

Aspect 29: A non-transitory computer-readable medium storing a set of instructions for wireless communication, the set of instructions comprising one or more instructions that, when executed by one or more processors of a device, cause the device to perform the method of one or more of Aspects 1-24.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A first mobile station for wireless communication, comprising:
a memory; and
one or more processors configured to, based at least in part on information stored in the memory:
transmit, to a second mobile station, a signal on each of multiple sidelink carriers;
receive, from the second mobile station, one or more signals on one or more of the multiple sidelink carriers;
select a primary carrier among the multiple sidelink carriers and a secondary carrier among the multiple sidelink carriers based at least in part on the one or more signals received on the one or more of the multiple sidelink carriers; and
negotiate, with the second mobile station, which of the multiple sidelink carriers are to be an agreed primary carrier and an agreed secondary carrier.

2. The first mobile station of claim 1, wherein the one or more processors, to negotiate which of the multiple sidelink carriers are to be the agreed primary carrier and the agreed secondary carrier, are configured to:
transmit, to the second mobile station, an indication of the primary carrier and the secondary carrier selected by the first mobile station; and
receive, from the second mobile station, a response to the indication, indicating that the second mobile station confirms the primary carrier and the secondary carrier selected by the first mobile station.

3. The first mobile station of claim 1, wherein the one or more processors, to negotiate which of the multiple sidelink carriers are to be the agreed primary carrier and the agreed secondary carrier, are configured to:
transmit, to the second mobile station, an indication of the primary carrier and the secondary carrier selected by the first mobile station; and
receive, from the second mobile station, a response to the indication that indicates that the second mobile station does not confirm the primary carrier and the secondary carrier selected by the first mobile station.

4. The first mobile station of claim 3, wherein the response indicates a selection of a primary carrier and a secondary carrier by the second mobile station.

5. The first mobile station of claim 1, wherein the one or more processors, to negotiate which of the multiple sidelink carriers are to be the agreed primary carrier and the agreed secondary carrier, are configured to:
receive, from the second mobile station, an indication of a primary carrier and a secondary carrier selected by the second mobile station;
generate a response to the indication based at least in part on the primary carrier and the secondary carrier selected by the first mobile station; and
transmit the response to the second mobile station.

6. The first mobile station of claim 5, wherein the response confirms the primary carrier and the secondary carrier selected by the second mobile station as the agreed primary carrier and the agreed secondary carrier.

7. The first mobile station of claim 5, wherein the response rejects the primary carrier and the secondary carrier selected by the second mobile station.

8. The first mobile station of claim 7, wherein the response suggests the primary carrier and the secondary carrier selected by the first mobile station for the agreed primary carrier and the agreed secondary carrier.

9. The first mobile station of claim 1, wherein the one or more processors are further configured to route a data radio bearer only to the agreed secondary carrier and duplicating a signaling radio bearer on all carriers of the multiple sidelink carriers.

10. The first mobile station of claim 1, wherein the one or more processors are further configured to duplicate a data radio bearer and a signaling radio bearer across all of the multiple sidelink carriers based at least in part on a channel busy ratio for the multiple sidelink carriers.

11. The first mobile station of claim 1, wherein the one or more processors are configured to negotiate further based at least in part on a channel busy ratio for the multiple sidelink carriers.

12. The first mobile station of claim 11, wherein the one or more processors are configured to transmit duplicates of a packet on one or more of the agreed primary carrier or the agreed secondary carrier based at least in part on a priority of the packet.

13. The first mobile station of claim 1, wherein the agreed primary carrier and the agreed secondary carrier are for unicast communication, and wherein the one or more processors are configured to transmit control information and data independently per carrier.

14. The first mobile station of claim 1, wherein the agreed primary carrier and the agreed secondary carrier are for unicast communications, and wherein the one or more processors are configured to transmit control information on the primary carrier and data on the secondary carrier.

15. The first mobile station of claim 1, wherein the agreed primary carrier and the agreed secondary carrier are for connection-based groupcast communications, and wherein the one or more processors are configured to determine a carrier capability of other mobile stations in a group of mobile stations that includes the first mobile station, based at least in part on capability information received from each of the other mobile stations.

16. The first mobile station of claim 15, wherein the one or more processors are configured to transmit, to the second mobile station, an indication of radio bearers that are to be duplicated on one or more carriers of the multiple sidelink carriers.

17. The first mobile station of claim 15, wherein the one or more processors are configured to transmit, to the second mobile station, an indication of a feedback channel per carrier or in a common carrier.

18. The first mobile station of claim 1, wherein the one or more processors are configured to generate a mapping between an application and one or more of the multiple sidelink carriers.

19. The first mobile station of claim 18, wherein the one or more processors are configured to assign the agreed primary carrier and the agreed secondary carrier to the application if the application supports all of the multiple sidelink carriers.

20. The first mobile station of claim 18, wherein the mapping indicates one or more supported carriers of the multiple sidelink carriers based at least in part on the application.

21. The first mobile station of claim 1, wherein the one or more processors are configured to:
transmit, to a network entity, one or more of a capability of the first mobile station or a location of the first mobile station; and
receive, from the network entity, an indication of the agreed primary carrier.

22. A network entity for wireless communication, comprising:
a memory; and
one or more processors configured to, based at least in part on information stored in the memory:
receive, from a mobile station, one or more of a capability of the mobile station or a location of the mobile station; and
transmit, to the mobile station, an indication of one or more of a primary carrier or a secondary carrier selected by the network entity based at least in part on the capability of the mobile station and the location of the mobile station.

23. The network entity of claim 22, wherein the network entity is a roadside unit.

24. The network entity of claim 22, wherein the network entity is a base station.

25. A method of wireless communication performed by a first mobile station, comprising:
transmitting, by the first mobile station to a second mobile station, a signal on each of multiple sidelink carriers;
receiving, by the first mobile station from the second mobile station, one or more signals on one or more of the multiple sidelink carriers;
selecting, by the first mobile station, a primary carrier among the multiple sidelink carriers and a secondary carrier among the multiple sidelink carriers based at least in part on the one or more signals received on the one or more of the multiple sidelink carriers; and
negotiating, by the first mobile station with the second mobile station, which of the multiple sidelink carriers are to be an agreed primary carrier and an agreed secondary carrier.

26. The method of claim 25, further comprising routing, by the first mobile station, a data radio bearer only to the agreed secondary carrier and duplicating, by the first mobile station, a signaling radio bearer on all carriers of the multiple sidelink carriers.

27. The method of claim 25, further comprising duplicating, by the first mobile station, a data radio bearer and a signaling radio bearer across all of the multiple sidelink carriers based at least in part on a channel busy ratio for the multiple sidelink carriers.

28. The method of claim 25, wherein the negotiating is further based at least in part on a channel busy ratio for the multiple sidelink carriers.

29. The method of claim 25, further comprising generating, by the first mobile station, a mapping between an application and one or more of the multiple sidelink carriers.

30. A method of wireless communication performed by a network entity, comprising:
receiving, by the network entity from a mobile station, one or more of a capability of the mobile station or a location of the mobile station; and
transmitting, by the network entity to the mobile station, an indication of one or more of a primary carrier or a secondary carrier selected by the network entity based at least in part on the capability of the mobile station and the location of the mobile station.
